(19) United States
(12) Patent Application Publication
(10) Pub. No.: US 2013/0131972 A1
(43) Pub. Date: May 23, 2013

(54) COMPUTING-DEVICE LOCALIZATION BASED ON INERTIAL SENSORS

(71) Applicants: SUMIT KUMAR, BELLEVUE, WA (US); SACHIN PATNEY, BELLEVUE, WA (US); CHUNSHUI ZHAO, BEIJING (CN); ABHIJIT PURSHOTTAM JOSHI, REDMOND, WA (US)

(72) Inventors: SUMIT KUMAR, BELLEVUE, WA (US); SACHIN PATNEY, BELLEVUE, WA (US); CHUNSHUI ZHAO, BEIJING (CN); ABHIJIT PURSHOTTAM JOSHI, REDMOND, WA (US)

(73) Assignee: MICROSOFT CORPORATION, REDMOND, WA (US)

(21) Appl. No.: 13/300,053

(22) Filed: Nov. 18, 2011

(51) Int. Cl. G01C 21/16

(52) U.S. Cl. 701/409

(57) ABSTRACT

Technology is described for determining a location at which a computing device is positioned. For example, a computing device is positioned in an area (e.g., building), and a map (e.g., floor plan) is retrieved that depicts the area. An initial location of the computing device is determined with respect to the map. Inertial sensors record motion inputs (e.g., acceleration, orientations, etc.), which are analyzed to determine a path along which the computing device moves. The path is applied to the initial location to determine an updated location at which the computing device may be located.

### BACKGROUND

A location of a computing device may sometimes be determined using Global Positioning System (GPS) based techniques. However, signals used to facilitate GPS-based techniques are sometimes too weak to determine the location of the computing device, such as when the computing device is indoors. Accordingly, technology other than GPS may be leveraged to determine a location of a computing device.

### SUMMARY

This summary provides a high-level overview of the disclosure and of various aspects of the invention and introduces a selection of concepts that are further described in the detailed-description section below. This summary is not intended to identify key features or essential features of the claimed subject matter, nor is it intended to be used as an aid in isolation to determine the scope of the claimed subject matter.

In brief and at a high level, this disclosure describes determining a location at which a computing device is positioned. For example, a computing device is positioned in an area, and a map is retrieved that depicts the area. An initial location of the computing device is determined with respect to the map. Inertial sensors record motion inputs, which are analyzed to determine a path along which the computing device moves. The path is applied to the initial location to determine an updated location at which the computing device may be located.

### BRIEF DESCRIPTION OF THE DRAWINGS

Illustrative embodiments of the present invention are described in detail below with reference to the attached drawing figures, which are incorporated by reference herein, wherein:

FIG. 1 depicts an exemplary computing device;

FIG. 2 is a schematic diagram depicting an exemplary environment of components that may determine a computing-device location;

FIG. 3 depicts a chart of exemplary inertial-sensor input; and

FIG. 4 depicts a flow diagram illustrating an exemplary method.

### DETAILED DESCRIPTION

The subject matter of select embodiments of the present invention is described with specificity herein to meet statutory requirements. But the description itself is not intended to define what is regarded as inventive, which is what the claims do. The claimed subject matter might be embodied in other ways to include different steps or combinations of steps similar to the ones described in this document, and in conjunction with other present or future technologies. Terms should not be interpreted as implying any particular order among or between various steps herein disclosed unless and except when the order of individual steps is explicitly stated.

An embodiment of the present invention is directed to determining a location at which a computing device is positioned with respect to a mapped area, such as inside a building or among various mapped geographical landmarks. For example, an initial computing-device location is determined that includes a position of the computing device on a map (e.g., building floor plan, shopping-district map, business-park map, etc.) depicting the mapped area. When the computing device moves, an inertial sensor records motion inputs (e.g., acceleration values) that describe the motion. The motion inputs are analyzed to calculate a distance and direction in which the computing device moved. The distance and the direction are applied to the initial computing-device location to determine an updated computing-device location, which includes an updated position of the computing device on the map.

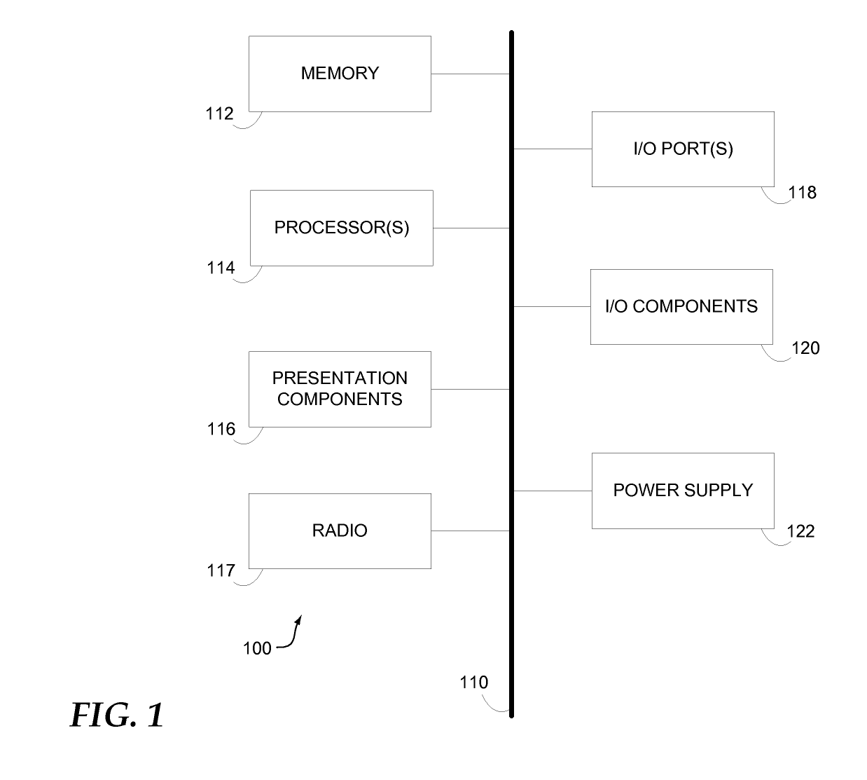

As such, a computing device may be utilized when determining the location of the computing device. That is, a computing device may be utilized to determine its own location or one computing device may be used to determine the location of another computing device. Turning to FIG. 1, an exemplary computing device 100 is depicted. Computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated. Computing device 100 may be a variety of different types of computing devices. For example, computing device 100 may be a cell phone, smart phone, personal digital assistant (PDA), tablet, netbook, laptop, or other mobile computing device or hand-held computing device. In addition, computing device may be a desktop, workstation, server computer, or other type of computing device. These are merely examples of computing devices and are not meant to limit the scope of the term computing device.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices or components: memory 112, processor(s) 114, presentation component(s) 116, radio 117, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention.

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media includes volatile and nonvolatile, non-transitory, removable and non-removable media, implemented in any method or technology for storage of information such as computer-readable instructions, data structures, program modules or other data. Computer storage media includes RAM; ROM; EEPROM; flash memory or other memory technology; CD-ROM; digital versatile disks (DVD) or other optical disk storage; magnetic cassettes, magnetic tape, and magnetic disk storage or other magnetic storage devices, each of which can be used to store the desired information and which can be accessed by computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media, such as acoustic, RF, infrared and other wireless media. Combinations of any of the above should also be included within the scope of computer-readable media.

Radio 117 represents a radio that facilitates communication with a wireless telecommunications network. Illustrative wireless telecommunications technologies include CDMA, GPRS, TDMA, GSM, and the like. In some embodiments, radio 117 might also facilitate other types of wireless communications including Wi-Fi communications and GIS communications.

I/O ports 118 allow computing device 100 to be logically coupled to other devices including I/O components 120, some of which may be built in. Illustrative components include a microphone, joystick, game pad, satellite dish, scanner, printer, wireless device, etc.

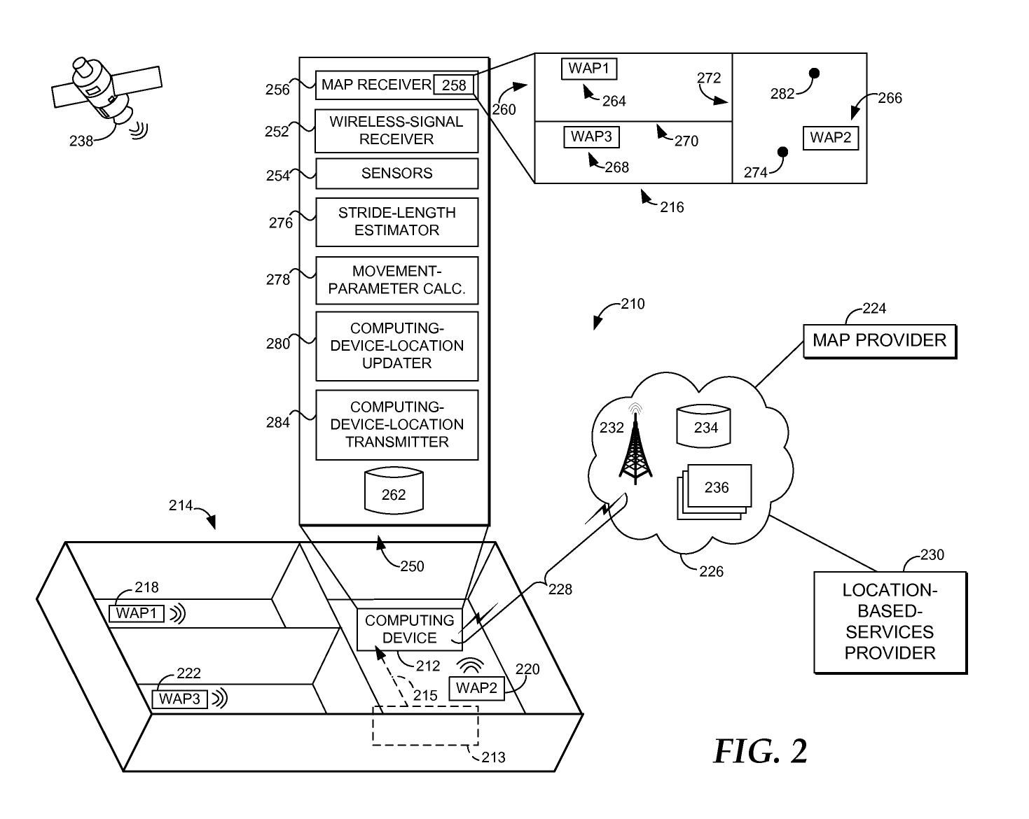

Referring now to FIG. 2, an exemplary environment 210 is depicted in which a location of a computing device 212 may be determined. Computing device 212 may be similar to computing device 100 depicted in FIG. 1, such that computing device 212 includes some or all of the components described with respect to computing device 100. Computing device 212 may be a variety of different types of computing devices, and in an exemplary aspect, computing device 212 may be a cell phone, smartphone, PDA, tablet, netbook, or other hand-held mobile computing device.

In FIG. 2, a ghost view of computing device 212 is depicted as computing device 213. Moreover, an arrow 215 is depicted to illustrate that the computing device 212 moved from an initial position depicted by computing device 213. A computing device may move when a user having the computing device on his/her person traverses from one position to a next. For example, a user may be holding the computing device or have the computing device kept in a bag or pocket and the user may walk from one position to another. As such, an embodiment of the present invention is directed to determining a location of computing device 212, as well as determining locations along the path depicted by arrow 215. Moreover, all of the components described as part of computing device 212 would also be included in computing device 213, since computing device 213 merely represents computing device 212 at an earlier instant in time and before the movement depicted by arrow 215.

Computing device 212 may comprise other components. For illustrative purposes, exploded view 250 is depicted to illustrate a variety of other components that may be included in computing device 212. For example, exploded view 250 illustrates that computing device 212 may include a wireless-signal receiver 252, which may function similarly to radio 117 depicted in FIG. 1. In addition, computing device 212 may include one or more positional sensors 254 that detect and measure motion or position of computing device 212. For example, sensors 254 may include one or more inertial sensors, such as an accelerometer, a gyroscope, or a combination thereof. These are merely examples of inertial sensors and a variety of other inertial sensors may also be included in computing device 212. Other types of sensors 254 may include a magnetometer, a barometer, and various other sensors that detect an environment or condition in which computing device exists. Exploded view 250 depicts other computing components that will be described in more detail in other portions of this description.

Computing device 212 is positioned in an area 214 (e.g., building) for which a map (e.g., 216) has been created. Although for illustrative purposes map 216 is depicted as being stored in a component of computing device 212, map 216 (or a copy thereof) may likewise be stored by map provider 224, which transmits the map to computing device 212. Area 214 includes multiple wireless access points (WAP) 218, 220, and 222 that send signals to computing device 212. For example, each WAP may leverage Wi-Fi technology to enable computing device 212 to connect to a network. For illustrative purposes, area 214 is depicted as a building; however, area 214 might also be other types of areas that are mapped and that may include multiple WAPs. For example, area 214 might be an office-building park, such that computing device 212 is positioned among multiple buildings. Area 214 may also be an outdoor shopping district having multiple stores, each of which includes a WAP.

Computing device 212 is also in communication with network 226 by way of wireless connectivity 228. Through wireless connectivity 228, network 226 may provide various services to computing device 212, such as phone services, text-messaging services, application services, and Internet access. For example, using wireless connectivity 228 and network 226, location-based-services provider 230 may be able to provide services to computing device 212. As such, network 226 includes various components, such as a base station or communications tower 232, datastores 234, and servers 236.

Components of network 226 may be used to determine a location of computing device 212. For example, tower 232 may be associated with a certain cell or region to which tower 232 transmits a signal, such that when computing device 212 receives the signal of tower 232, a location of computing device 212 can be determined. Moreover, when multiple towers 232 may be used to execute a triangulation, which is used to determine a location of computing device 212. Environment 210 also includes a GPS satellite 238, which may communicate either directly with computing device 212 or indirectly with computing device 212 by way of network 226. For example, GPS satellite 238 may be used to determine a location of computing device 212.

However, in some situations, components of network 226 and/or GPS satellite 238 may not be able to determine an accurate location of computing device 212, such as when a position of computing device 212 interferes with signals transmitted between computing device 212 and network 226, or between computing device 212 and GPS satellite 238. For example, when a computing device 212 is moved to an indoor location (e.g., inside area 214) or among multiple buildings or structures, the surrounding environment of the computing device 212 may interfere with signals.

As such, an embodiment of the present invention leverages technology that may be an alternative to GPS and that may already be integrated into an infrastructure, in order to determining a location at which a computing device 212 is positioned with respect to a mapped area 214. That is, as indicated in other portions of this description, an embodiment of the present invention is directed to determining a location of computing device 212, as well as determining locations along the path depicted by arrow 215.

In an exemplary aspect, computing device 212 includes a map receiver 256 that receives a map 216 depicted mapped area 214. That is, data item 258 is depicted in an exploded view 260 for illustrative purposes, and data item 258 may comprise the map 216. Map 216 may be received in various ways. For example, map 216 may be retrieved from a datastore 262 or other storage component of computing device 212. For example, map 216 may be stored in a cache or may be stored as part of a location-determination application that runs on computing device 212. Moreover, map 216 may be received from map provider 224 by way of network 226. For example, when computing device 212 enters mapped area 214, a communication may be sent from computing device 212 to map provider 224, thereby indicating to map provider that computing device 212 is in mapped area 214. In response, map provider may transmit map 216 to computing device 212.

Map 216 includes positions of WAPs 218, 220, and 222 that are positioned throughout mapped area 214. For example, map 216 depicts position 264 corresponding to WAP1 218, position 266 corresponding to WAP2 220, and position 268 corresponding to WAP3 222. Moreover, map 216 depicts various other infrastructure elements 270 and 272 that correspond to areas of mapped area 214 through which navigation is not likely or allowed, such as walls. Walls are just one example of a non-navigatable area, and other examples may include floors, ceilings, and other structural elements of mapped area 214. Moreover, non-navigatable areas may be human defined, such as a private or secure area of mapped area 214 that to which public access is not allowed. These exemplary non-navigatable areas may all be depicted on map 216.

In an exemplary embodiment of the present invention, an initial computing-device location is determined that includes a position of the computing device 213 relative to the map 216 depicting the mapped area 214. For example, an initial computing-device location is represented by a filled-in-circle symbol 274 on map 216, such that symbol 274 represents a location of computing device 213 (i.e., before the movement represented by arrow 215).

An initial computing-device location may be determined in various manners. For example, as described in other portions of this description, computing device 212 (as well as computing device 213 that represents computing device 212 pre-movement) includes wireless-signal receiver 252. As such, wireless-signal receiver 252 may receive signals from WAPs 218, 220, and 222, as well as detect respective strengths of signals received from WAPs 218, 220, and 222. Accordingly, in an aspect of the invention, the respective strengths are used to determine an initial computing-device location of computing device 213. For example, the initial computing-device location may be determined by executing a triangulation protocol. The initial computing-device location is then translated to a position on map 216 that is represented by filled-in-circle symbol 274.

As described in other portions of this description, arrow 215 represents a movement of computing device 212 (e.g., person possessing computing device 212 walking from one location to another). Accordingly, an embodiment of the present invention comprises recording by one or more positional sensors 254 inputs that may be used to infer a relative or absolute movement and/or position of computing device. That is, sensors 254 may be used to infer an absolute position of a computing device relative to a fixed geographical element or may be used to infer an approximate position relative to a previously determined device position.

In an exemplary aspect, positional sensors 254 may include one or more inertial sensors such as an accelerometer, a gyroscope, or a combination thereof. Inertial sensors may be 3-axis and may also include micro-electro-mechanical systems (MEMS). As such, the inertial sensor may record various inputs including acceleration and orientation (e.g., angular rate). Positional sensors 254 may also include a magnetometer, which may be separate from or combined with the inertial sensors. As such, adirection (e.g., azimuth) may also be recorded as an input.

As will be described in more detail, an acceleration refers to a change in velocity over a period of time, and may be used to assess, evaluate, and/or measure a person's stride. Moreover, as used in this description, the term “azimuth-measurement value” describes a degree or other measured quantity that the inertial sensor faces relative to a reference point. For example, North may be a reference point, such that an azimuth-measurement value describes a degree away from North that the inertial sensor points at a given instant in time. Furthermore, an orientation may be measured that describes a direction of movement relative to the azimuth-measurement value. As such, in exemplary aspects of the present invention, inputs may also be recorded by inertial sensor in a manner allows the inputs to be coordinated. For example, at any instant in time, an inertial sensor may experience an acceleration, an orientation or rotation, and a direction. As such, the various inputs may be coordinated in such a manner that it can be determined what acceleration value, orientation, and direction the inertial sensor experienced at a given instant in time.

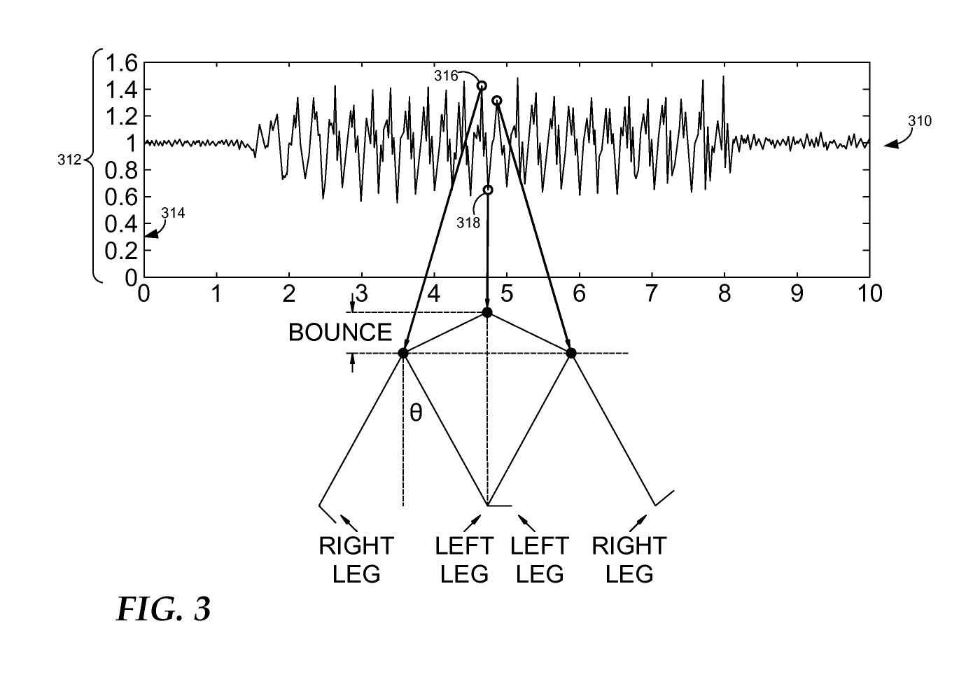

Referring briefly to FIG. 3, a graph 310 is depicted that charts a set of acceleration values 312 along the vertical axis 314. That is, the set of acceleration values 312 represent an exemplary set of acceleration values that may be recorded by the inertial sensor when a user possessing computing device 212 walks along the path depicted by arrow 215. Graph 310 depicts a series of acceleration peaks (e.g., peak 316), as well as a series of acceleration valleys (e.g., valley 318). A stick drawing 320 is illustrated below graph 310 to depict a correlation between acceleration values and a stride of a user that is walking. For example, an acceleration peak is experienced as a foot of a user, who possesses the computing device, strikes and pushes off the ground. In contrast, an acceleration valley is experienced when the user is mid-stride (i.e., when the non-striking foot passes the striking foot as the user prepares for his/her next step).

In an embodiment of the present invention, a change in acceleration values (ΔA) is calculated between an acceleration-peak value (e.g., 316) and an acceleration-valley value (e.g., 318). In addition, ΔA may be a magnitude of the three axis acceleration and Δθ (i.e., the difference of the angle). Moreover, an amount of time lapses (Δt) between a first time instant at which the acceleration-peak value is detected and a second time instant at which the acceleration-valley value is detected. That is, the acceleration-valley value is recorded at a first instant in time and the acceleration-peak value is recorded at a second instant in time. By calculating a difference between the first instant in time and the second instant in time, the amount of time that lapses (Δt) is calculated. Moreover, Δt may be determined based on a function of time lapse, such as frequency.

Referring back to FIG. 2, computing device 212 includes a stride-length estimator 276. As described with respect to FIG. 3, a correlation may exist between acceleration values and a user's stride. Accordingly, stride-length estimator applies the change in acceleration (ΔA) and the amount of time (Δt) that lapses in a stride-length-estimation algorithm to calculate an estimated stride length (S).

A stride-length-estimation algorithm may require a variety of different operations. In one embodiment, the stride-length-estimation algorithm represents a linear-equation group that is compiled from a set of test data. For example, a stride-length-estimation algorithm used in an embodiment of the present invention includes Formula I:

S=α₀+α₁ΔA+α₂Δt+α₃ΔA²+α₄Δt²

In Formula I, (S) represents an estimated stride length; ΔA represents a change in acceleration between an acceleration-peak value and an acceleration-valley value; and Δt represents a lapse in time between the acceleration-peak value and an acceleration-valley value. In addition, parameters α₀, α₁, α₂, α₃, α₄ represent values that are estimated by applying a least squares method to a corpus of test data.

The corpus of test data is generated by collecting various sets of data. For example, the strides of users are videotaped while walking from one position to another while the users possess (e.g., hold in hand) an inertial sensor. Video-derived input may include a measured stride lengths, which is derived by labeling the various positions at which feet strike the ground when walking. Respective distances between the various feet positions can be measured using a computer vision algorithm in order to compute a real step length according to feet positions on the video. The video is synced by time with inputs (e.g., acceleration) collected by the inertial sensor, such that an acceleration value can be correlated with a foot strike. As such, the change in acceleration between two consecutive feet strikes can be correlated with a measured stride length between the two consecutive feet strikes.

Based on these data sets (e.g., correlated acceleration changes [ΔA], changes in time [Δt], and stride lengths [S]), various linear models may be generated. For example, Formula I represents an exemplary linear model that may be generated in which parameters α₀, α₁, α₂, α₃, α₄ are unknown. However, by collecting a sufficient amount of test data (i.e., ΔA, Δt, and [S]), a linear equation group can be determined, such as:

$$[ \begin{matrix}1 & Δ {A}^{′} & {( Δ {A}^{2} )}^{′} & Δ {T}^{′} & {( Δ {T}^{2} )}^{′} \\ 1 & Δ {A}^{″} & {( Δ {A}^{2} )}^{″} & Δ {T}^{″} & {( Δ {T}^{2} )}^{″} \\ & … & … & & … \\ 1 & Δ {A}^{n} & {( Δ {A}^{2} )}^{n} & Δ {T}^{n} & {( Δ {T}^{2} )}^{n}\end{matrix} ] [ \begin{matrix}{a}_{0} \\ {a}_{1} \\ {a}_{2} \\ {a}_{3} \\ {a}_{4}\end{matrix} ] = [ \begin{matrix}{S}^{′} \\ {S}^{″} \\ … \\ {S}^{n}\end{matrix} ]$$

Based on the linear equation group, parameters α₀, α₁, α₂, α₃, α₄ may be estimated by a least square method.

As such, the estimated parameters α₀, α₁, α₂, α₃, α₄ may be applied in Formula I in order to calculate an estimated stride length (S). That is, when change in acceleration (ΔA) and a change in time (Δt) (i.e., amount of time between the acceleration peak and the acceleration valley) are derived from data recorded by inertial sensor 254, stride-length estimator can apply ΔA and Δt in Formula I with the estimated parameters α₀, α₁, α₂, α₃, α₄ to calculated an estimated stride length (S).

As indicated above, input derived from inertial sensor 254 may be combined in various ways to describe a movement of computing device 212. Accordingly, movement-parameter calculator 278 may combine the estimated stride length with an azimuth-measurement value and an orientation-measurement value (e.g., angular rate) in order to calculate an estimated movement parameter. As such, an estimated movement parameter may indicate a direction and distance in which the computing device 212 is detected to have moved.

In an embodiment of the present invention, each estimated movement parameter is associated with one or more probabilities. That is, there may be an amount of “noise” incorporated into the analysis to account for imperfectly accurate measurements. As such, a Bayesian filter may be used to evaluate the noise. For example, a particle-filter method may be used to generate a set of particles that describe an estimated movement parameter, wherein each of the particles has a respective probability. The particles may then be evaluated based on observations to determine whether or not the particle is likely to represent the actual movement of the computing device.

For example, the particles may be mapped onto map 216 in order to determine whether one or more of the particles conflict with a non-navigatable area. As described with respect to map 216, a non-navigatable area may include a wall, floor, ceiling, structural element, human-defined area, or other area on map 216 through which navigation is unlikely. When a particle is deemed to conflict with a non-navigatable area, the particle is removed from the set and a distribution of the particles (without the removed particle) is recalculated to generate the estimated movement parameter.

In a further example, a movement of computing device 212 is measured by analyzing a plurality of consecutive acceleration changes in order to estimate stride length of a plurality of consecutive strides. Moreover, the particle-filter method is applied to each analysis to create an estimated movement path based on movement parameters having the highest probability.

In a further aspect, computing-device-location updater 280 applies the estimated movement parameter to the initial computing-device location (i.e., represented by 274) to calculate an updated computing-device location comprising an updated position of the computing device on the map. For example, when an estimated movement parameter is calculated to describe a movement depicted by arrow 215 and is applied to position 274, an updated computing-device location include the updated position represented by filled-in-circle 282.

Once a location of computing device 212 is determined within mapped area 214, various types of services may be provided to computing device 212. For example, computing-device-location-transmitter 284 may transmit position 282 to location-based-services provider 230. In turn, location-based-services provider 230 may transmit various information to computing device 212 by way of network 226, based on a context of computing device 212. For example, if mapped area 214 is an office building, hotel, or other large structure, provider 230 may transmit directions to a specific location within mapped area 214. Moreover, if mapped area 214 is a shopping area (e.g., shopping mall), provider 230 may transmit advertisements relevant to a store located near to computing device 212. In a further aspect, if provider 230 is notified of respective locations of various computing devices (e.g., two or more friends possessing respective computing devices), provider 230 may provide directions from a location of one computing device to a different location of another computing device. These are merely examples of types of information that may be transmitted by provider, and a variety of other types of information may also be sent.

Because a location of computing device 212 may be deemed sensitive or private information, computing device 212 (or an application running on computing device 212) may request a user's permission to transmit the location 282 to another entity. For example, a prompt may be presented on the computing-device display that requires a user to provide input, which approves transmitting the location 282 to another entity.

In a further aspect, a prompt is used to expressly verify that the computing device 212 is in the possession of a person. That is, some embodiments of the invention assume that detected movement is a result of a person taking strides (e.g., walking, running, etc.). As such, a prompt may be used to request feedback from a user that verifies the computing device is in fact in the possession of a user. Based on the user's feedback, it may be inferred that detected movement is a result of the user's strides. Such a prompt may be presented at various time instances, such as when a computing device detects a movement. By verifying that the computing device is in the possession of a user, extraneous or unnecessary operations may be avoided when a movement is not in fact caused by a person striding.

In another aspect, verification that the computing device is in the possession of a user may be implied based on other operations being executed by the computing device. For example, if the computing device is currently being used to execute other user-interactive applications (e.g., exchanging text messages, engaging in a voice call, navigating the Internet, etc.), it may be inferred or implied that the computing device is in the possession of a user and that movement is a result of a person's strides. Executing a check to determine if other user-interactive applications are running may be done at various instances, such as when a movement is detected.

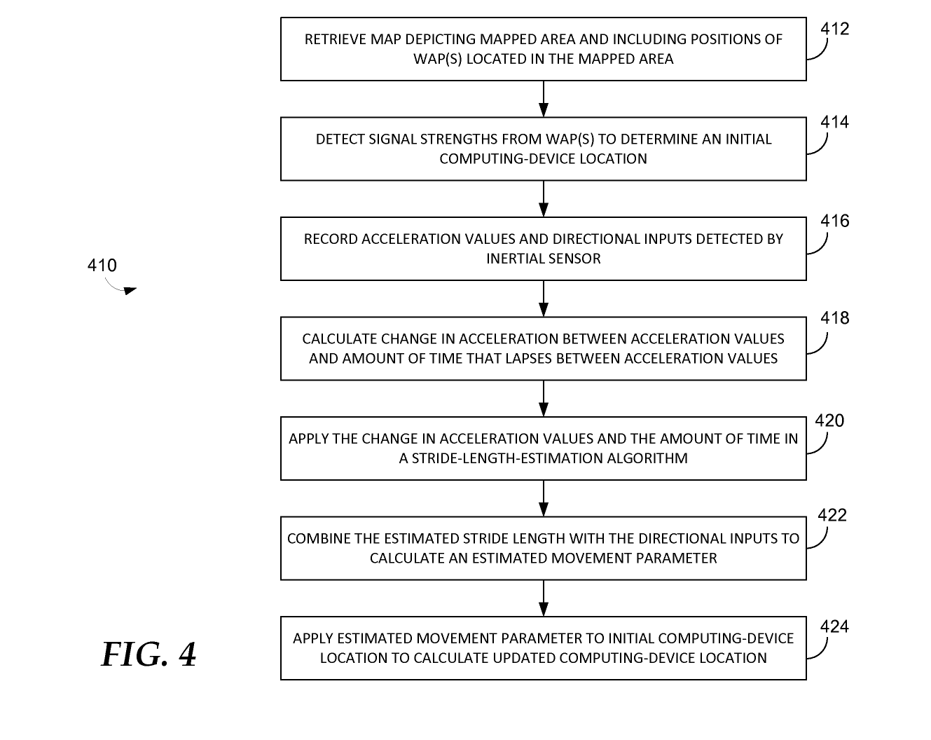

Referring now to FIG. 4, a flow diagram is depicted that illustrates a method 410 of determining a location at which a computing device is positioned with respect to a mapped area. When describing method 410, reference may also be made to FIGS. 2 and 3 for explanatory purposes. Moreover, in an embodiment of the present invention, method 410 may be at least partially embodied on computer-storage media as a set of computer-executable instructions that, when executed, perform the method 410.

At step 412, a map (e.g., 216) is retrieved depicting the mapped area (e.g., 214) and including respective positions (e.g., 264, 266, and 268) of WAPs (e.g., 218, 220, and 222) located in the mapped area. As indicated in other portions of this description, the map may be retrieved from storage of the computing device 212 or may be received from a remote map provider 224.

Step 414 includes detecting respective strengths of signals received from one or more of the WAPs, wherein the respective strengths are used to determine an initial computing-device location comprising a position (e.g., 274) of the computing device on the map depicting the mapped area. For example, a Wi-Fi based triangulation protocol may be executed to determine an initial computing-device location.

Moreover, at step 416 an inertial sensor (e.g., accelerometer, gyroscope, and/or magnetometer) records a set of acceleration values and directional inputs that describe a movement of the computing device. Examples of acceleration values are those depicted in FIG. 3. In addition, examples of directional inputs include an angular rate measured by a gyroscope and an azimuth measured by a magnetometer.

Step 418 includes calculating a change in acceleration values (ΔA) between an acceleration-peak value and an acceleration-valley value, wherein an amount of time (Δt) lapses between a first time instant at which the acceleration-peak value is detected and a second time instant at which the acceleration-valley value is detected. For example, FIG. 3 depicts peak 316 and valley 318, such that a change in acceleration may be calculated by determining a difference between the two acceleration values. Moreover, each of peak 316 and valley 318 are recorded at a respective instant in time, such that an amount of time (Δt) can be calculated that lapses between recording the peak and recording the valley.

Step 420 includes applying the change in acceleration values (Δt) and the amount of time (Δt) in a stride-length-estimation algorithm (e.g., Formula I) to calculate an estimated stride length (S). Moreover, in step 422 the estimated stride length is combined with the directional inputs (e.g., angular rate and azimuth) to calculate an estimated movement parameter, which indicates a direction and distance in which the computing device is detected to have moved.

Although not depicted in FIG. 4, the estimated stride length may be further evaluated by applying a particle-filter method, which generates a plurality of particles having a distribution that represents the estimated movement parameter. Pursuant to the particle-filter method, a particle of the plurality of particles is removed from the distribution when the particle conflicts with a non-navigatable area depicted on the map. Once the particle has been removed, the distribution is recalculated to update the estimated movement parameter.

Step 424 includes applying the estimated movement parameter to the initial computing-device location to calculate an updated computing-device location comprising an updated position (e.g., 282) of the computing device on the map. As indicated above, an updated position of a computing device may be used for various location-based services.

Many different arrangements of the various components depicted, as well as components not shown, are possible without departing from the scope of the claims below. Embodiments of our technology have been described with the intent to be illustrative rather than restrictive. Alternative embodiments will become apparent readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer-storage media having computer-executable instructions embodied thereon that, when executed, perform a method of determining a location at which a computing device is positioned with respect to a mapped area, the method comprising:
retrieving a map depicting the mapped area and including respective positions of Wireless access points located in the mapped area;
detecting respective strengths of signals received from one or more of the wireless access points, wherein the respective strengths are used to determine an initial computing-device location comprising a position of the computing device on the map depicting the mapped area;
recording by an inertial sensor a set of acceleration values and directional inputs that describe a movement of the computing device;
calculating a change in acceleration values between an acceleration-peak value and an acceleration-valley value, wherein an amount of time lapses between a first time instant at which the acceleration-peak value is detected and a second time instant at which the acceleration-valley value is detected;
applying the change in acceleration values and the amount of time in a stride-length-estimation algorithm to calculate an estimated stride length;
combining the estimated stride length with the directional inputs to calculate an estimated movement parameter, which indicates a direction and distance in which the computing device is detected to have moved; and
applying the estimated movement parameter to the initial computing-device location to calculate an updated computing-device location comprising an updated position of the computing device on the map.

2. The media of claim 1, wherein the initial computing-device location is determined by executing a triangulation protocol.

3. The media of claim 1, wherein recording by the inertial sensor comprises recording respective measurements detected by an accelerometer, a gyroscope, and a magnetometer.

4. The media of claim 1 further comprising, applying a Bayesian filter to the estimated movement parameter to generate a plurality of particles having a distribution that represents the estimated movement parameter, wherein a particle of the plurality of particles is removed from the distribution when the particle conflicts with a non-navigatable area depicted on the map.

5. The media of claim 1, wherein the stride-length-estimation algorithm comprises a summation of:
a first test-group derived parameter,
a first quotient of the change in acceleration values and a second test-group derived parameter,
a second quotient of the amount of time and a third test-group derived parameter,
a third quotient of a fourth test-group derived parameter and a square of the change in acceleration values, and
a fourth quotient of a fifth test-group derived parameter and a square of the amount of time.

6. The media of claim 5, wherein test-group derived parameters are calculated by analyzing test-group data, which includes a plurality of known stride lengths, each of which is matched with a respective known change in acceleration and a respective known amount of time.

7. The media of claim 6, wherein analyzing the test-group data comprises applying a linear least-squares analysis to data points generated by the plurality of known stride lengths, the respective known changes in acceleration and the respective known amounts of time.

8. A method of determining a location at which a computing device is positioned with respect to a mapped area, the method comprising:
detecting by a signal receiver respective strengths of signals received from one or more wireless access points, wherein the respective strengths are used to determining an initial computing-device location comprising a position of the computing device on a map depicting the mapped area;
recording by an inertial sensor a set of acceleration values and directional inputs that describe a movement of the computing device;
calculating a change in acceleration values between an acceleration-peak value and an acceleration-valley value, wherein an amount of time lapses between a first time instant at which the acceleration-peak value is detected and a second time instant at which the acceleration-valley value is detected;
applying the change in acceleration values and the amount of time in a stride-length-estimation algorithm to calculate an estimated stride length;
combining the estimated stride length with the directional inputs to calculate an estimated movement parameter, which indicates a direction and distance in which the computing device is detected to have moved; and
applying the estimated movement parameter to the initial computing-device location to calculate an updated computing-device location comprising an updated position of the computing device on the map.

9. The method of claim 8, wherein the initial computing-device location is determined by executing a triangulation protocol.

10. The method of claim 8, wherein recording by the inertial sensor comprises recording respective measurements detected by an accelerometer, a gyroscope, and a magnetometer.

11. The method of claim 8 further comprising, applying a particle-filter method to the estimated movement parameter to generate a plurality of particles having a distribution that represents the estimated movement parameter, wherein a particle of the plurality of particles is removed from the distribution when the particle conflicts with a non-navigatable area depicted on the map.

12. The method of claim 8,
wherein the stride-length-estimation algorithm comprises a formula represented by S=α₀+α₂ΔA+α₂Δt+α₃ΔA²+α₄Δt²,
wherein (S) represents an estimated stride length,
wherein ΔA represents the change in acceleration values,
wherein Δt represents the amount of time, and
wherein α₀, α₁, α₂, α₃, α₄ represent test-group derived parameters.

13. The method of claim 12, wherein test-group derived parameters are calculated by analyzing test-group data, which includes a plurality of known stride lengths, each of which is matched with a respective known change in acceleration and a respective known amount of time.

14. The method of claim 13, wherein analyzing the test-group data comprises applying a linear least-squares analysis to data points generated by the plurality of known stride lengths, the respective known changes in acceleration and the respective known amounts of time.

15. A computing device comprising a processor coupled with computer-storage media, which store computer-executable instructions thereon that, when executed by the computing device, perform a method of determining a location at which a computing device is positioned with respect to a mapped area, the computing device comprising:
a map receiver that receives a map depicting the mapped area and that depicts respective positions of wireless access points located in the mapped area;
a wireless-signal receiver that receives signals from the wireless access points and that measures respective signal strengths of the signals, which are used to determine an initial computing-device location comprising a position of the computing device on the map depicting the mapped area;
an inertial sensor that records a set of acceleration values and directional inputs that describe a movement of the computing device,
wherein a change in acceleration values exists between an acceleration-peak value and an acceleration-valley value, and
wherein an amount of time lapses between a first time instant at which the acceleration-peak value is detected and a second time instant at which the acceleration-valley value is detected;
a stride-length estimator that leverages the processor to apply the change in acceleration values and the amount of time in a stride-length-estimation algorithm to calculate an estimated stride length;
a movement-parameter calculator that leverages the processor to combine the estimated stride length with the directional inputs to calculate an estimated movement parameter, which indicates a direction and distance in which the computing device is detected to have moved; and
a computing-device-location updater that applies the estimated movement parameter to the initial computing-device location to calculate an updated computing-device location comprising an updated position of the computing device on the map.

16. The computing device of claim 15, wherein the inertial sensor comprises an accelerometer, a gyroscope, a magnetometer, or a combination thereof.

17. The computing device of claim 15,
wherein the movement-parameter calculator applies a particle-filter method to the estimated movement parameter to generate a plurality of particles having a distribution that represents the estimated movement parameter,
wherein a particle of the plurality of particles is removed from the distribution when the particle conflicts with a non-navigatable area depicted on the map, and
wherein the movement-parameter calculator recalculates the distribution to account for removal of the particle.

18. The computing device of claim 15, wherein the stride-length-estimation algorithm comprises a summation of:
a first test-group derived parameter,
a first quotient of the change in acceleration values and a second test-group derived parameter,
a second quotient of the amount of time and a third test-group derived parameter,
a third quotient of a fourth test-group derived parameter and a square of the change in acceleration values, and
a fourth quotient of a fifth test-group derived parameter and a square of the amount of time.

19. The computing device of claim 15, wherein the directional inputs comprise an angular rate and an azimuth-measurement value.

20. The computing device of claim 15 further comprising, a computing-device-location transmitter that sends the updated computing-device location to a server to facilitate location-based services that are received by the computing device.
